(19) United States
(12) Patent Application Publication
(10) Pub. No.: US 2006/0081796 A1
(43) Pub. Date: Apr. 20, 2006

(54) Image reading apparatus

(75) Inventor: Masahiro Umemura, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Medical & Graphic, Inc., Tokyo (JP)

(21) Appl. No.: 11/251,225

(22) Filed: Oct. 14, 2005

(30) Foreign Application Priority Data
Oct. 18, 2004 (JP) JP2004-302783

(51) Int. Cl. G03B 42/08

(52) U.S. Cl. 250/589

(57) ABSTRACT

The image reading apparatus is providing with an optical unit 1 that illuminates the stimulable phosphor plate P with excitation light L1 from the light source while scanning it and reads the image information by condensing the photo-stimulated luminescence light emitted from the stimulable phosphor plate P and carrying out photoelectric conversion of this light, and a linear motor 7 that moves the stimulable phosphor plate P. In addition, it is provided with connecting means 6 and 61 that travel along with the stimulable phosphor plate P, a rotating device 92 and 93 that rotates due to the movement of the stimulable phosphor plate P transmitted via the connecting means 6 and 61, a rotation detecting device 5 that detects the rotational speed of the rotating device 92 and 93, and a speed control section 100 that controls the linear motor 7 by comparing the result of detection by the rotation detecting device 5 with a previously determined set speed.

This application is based on Japanese Patent Application No. 2004-302783 filed on Oct. 18, 2004 in Japanese Patent Office, the entire content of which is hereby incorporated by reference.

### BACKGROUND OF THE INVENTION

The present invention relates to image forming apparatuses, particularly to image reading apparatuses which have excellent scanning transport characteristics of stimulable phosphor plate, which are ideally suitable for application in the medical and printing fields.

Radiographic images such as X-ray images are used extensively for diagnosis of illness. Conventionally, in order to obtain such radiographic images, the so-called radiographs were used in which the X-rays passing through the subject impinged on a phosphor layer (fluorescent screen) thereby generated visible light, and this visible light impinged on a film using silver salts as in normal photography and this film was developed. However, in recent years, methods that use no films coated with silver salts but directly take out-images from the phosphor layer have been devised.

In an example of such a method, the radiation that has passed through the subject such as the patient's body is made to be absorbed by a phosphor. After that, this phosphor is, for example, excited by light or thermal energy thereby emits the radiation energy accumulated in the phosphor due to the above absorption, as fluorescent light, and finally this light is detected to generate the image. This is an example using a stimulable phosphor plate which is prepared by forming a stimulable phosphor layer on a base support. The radiographic image is obtained as digital image data by making the radiation that has passed through the subject impinge on the stimulable phosphor layer of this stimulable phosphor plate and forming a latent image by accumulating the radiation energy corresponding to the radiation transmittance of each part of the subject. Thereafter, the radiographic image is obtained by emitting the radiation energy accumulated in each part by scanning this stimulable phosphor layer with a stimulation exciting light beam, and converting this energy into light, and converting the intensity variations of this light into image data using a photoelectric conversion device such as a photomultiplier, etc.

Based on such digital image data, image formation is made on a silver halide film sheet or the image is outputted on a CRT, etc., thereby making it visible. In addition, the digital image data is stored in an image storage device such as a semiconductor storage device, a magnetic storage device, or an optical disk storage device. Thereafter, it can be read out from the image storage device when necessary and can be converted into a visible form using a silver halide film or a CRT display, etc.

However, when scanning a stimulable phosphor plate with a stimulation exciting light beam, the image reading section (the optical unit) should be moved accurately at a constant speed relative to the stimulable phosphor plate. In other words, speed uniformity is required of the transporting body, and it is necessary to carry out high performance of speed control.

Therefore, in the conventional technology, an image reading apparatus has been known in which a linear motor is used as a drive source of the transporting body and the stimulable phosphor plate is moved relative to the image reading section while guiding the stimulable phosphor plate by a guiding member, and the transporting body is moved smoothly by this (see, for example, Patent Document 1).

Patent Document 1: Tokkai No. 2003-248276

However, in the image reading apparatus described in the above Patent Document 1, since the speed control of the linear motor is done by a linear encoder, not only does the cost become extremely high but also there was the problem that the uniformity of the speed of the transportation body become deteriorated because a linear encoder of the optical type cannot detect properly if dirt or dust gets adhered to the linear scale section or the sensor section and it is not possible to obtain the desired movement speed. As a result, when scanning the stimulable phosphor plate with a stimulating excitation light beam, there were cases when image non-uniformity occurred and problems occurred in the diagnostic image.

In addition, in a linear encoder of the optical type it is extremely difficult to adjust the locational relationship between the linear scale section and the sensor section, and there were problems consuming time in the assembly adjustment, and when this assembly adjustment is insufficient, it is not possible to obtain the desired constant speed, and there was a problem that the speed uniformity becomes deteriorated also for this reason.

The present invention was made considering the above actual situations, and an object of the present invention is to provide an image reading apparatus which is of low cost, is easy to handle, and also thereby it is possible to obtain favorable diagnostic images without image non-uniformity.

### SUMMARY OF THE INVENTION

In order to solve the above problems, the invention of Item 1 has a feature that, in an image reading apparatus that reads out image information by illuminating, with excitation light, a stimulable phosphor plate provided with a stimulable phosphor sheet, the apparatus is provided with an optical unit that reads out the image information by emitting the excitation light from the light source onto the stimulable phosphor plate while scanning it, condenses the photo-stimulated luminescence light emitted from the stimulable phosphor plate and carries out photoelectric conversion of this light, a linear motor that moves the stimulable phosphor plate, a connecting device that travels along with the stimulable phosphor plate, a rotating device that rotates due to transmission of the movement of the stimulable phosphor plate via the connecting device, a rotation detecting device that detects the speed of rotation of the rotating device, and a control device that controls the linear motor by comparing the result of detection from the rotation detecting device with a previously established set speed.

According to the invention of Item 1, the stimulable phosphor plate is moved by the linear motor, and along with this, the rotating device rotates due to this movement being transmitted to the rotating device via the connecting device, and the rotation detecting device detects that rotational speed. Thereafter, the linear motor is controlled so that the movement of the stimulable phosphor plate is made at a constant speed by the control device comparing the result of the speed detection of the rotation detecting device with the set speed. In this manner, since the speed control of the linear motor is being done by the rotation detecting device, compared to the conventional method of using a linear encoder, not only can the cost be reduced but also there is no effect of dirt or dust adhesion on the accuracy of detection. Further, there is no need to carry out complicated assembly adjustments and there is no occurrence of problems due to insufficient assembly adjustments.

Therefore, it is possible to move the stimulable phosphor plate at a constant speed, and as a consequence, in the case of scanning the stimulable phosphor plate with stimulating excitation light, it is possible to obtain favorable diagnostic images without image non-uniformity.

The invention of Item 2 has a feature that, in an image reading apparatus that reads out image information by illuminating with excitation light a stimulable phosphor plate provided with a stimulable phosphor sheet, the apparatus is provided with an optical unit that reads out the image information by emitting the excitation light from the light source onto the stimulable phosphor plate while scanning it and condenses the photo-stimulated luminescence light emitted from the stimulable phosphor plate and carries out photoelectric conversion of this light, a linear motor that moves the optical unit, a connecting device that travels along with the optical unit, a rotating device that rotates due to transmission of the movement of the optical unit via the connecting device, a rotation detecting device that detects the speed of rotation of the rotating device, and a control device that controls the linear motor by comparing the result of detection from the rotation detecting device with a previously established set speed.

According to the invention of Item 2, the optical unit is moved by the linear motor, and along with this, the rotating device rotates due to this movement being transmitted to the rotating device via the connecting device, and the rotation detecting device detects that rotational speed. Thereafter, the linear motor is controlled so that the movement of the optical unit is made at a constant speed by the control device comparing the result of the speed detection of the rotation detecting device with the set speed. In this manner, since the speed control of the linear motor is being done by the rotation detecting device, compared to the conventional method of using a linear encoder, not only can the cost be reduced but also there is no effect of dirt or dust adhesion on the accuracy of detection. Further, there is no need to carry out complicated assembly adjustments and there is no occurrence of problems due to insufficient assembly adjustments.

Therefore, it is possible to move the optical unit at a constant speed, and as a consequence, in the case of scanning the stimulable phosphor plate with stimulating excitation light, it is possible to obtain favorable diagnostic images without image non-uniformity.

The invention of Item 3 has a feature that, in an image reading apparatus described in Items 1 and 2 above, the connecting device is provided with a vibration restraining mechanism to suppress the vibrations transmitted to the stimulable phosphor plate or the optical unit.

According to the invention of Item 3, since the vibrations transmitted to the stimulable phosphor plate or to the optical unit are suppressed by the vibration restraining mechanism, it is possible to improve the accuracy of detection, and to move the stimulable phosphor plate or the optical unit smoothly at a constant speed.

The invention of Item 4 has the feature that, in an image reading apparatus described in any one of Items 1 to 3 above, the connecting device is provided with a belt or a wire, the rotating device is provided with a plurality of pulleys, which are passed around by the belt or wire, and the diameters of the plurality of pulleys are all different.

According to the invention of Item 4, since the belt or the wire is passed around a plural number of pulleys with different diameters, for example, due to machining accuracy, the shape of the pulley may not be exactly circular, in the case when a plurality of pulleys with the same diameter are used in such situations and the phases of the pulleys match, the frequency of fluctuation occurrence on the length of the wire passing around these pulleys becomes higher. Because of this, although it is possible that there is some adverse effect on the accuracy of detection of the moving body or the optical unit, by using pulleys with different diameters as in the present invention, it is possible to reduce the frequency of the phase matching, and hence the accuracy of detection can be improved.

According to an image reading apparatus of the present invention, by carrying out speed control of the linear motor using a rotation detecting device, not only does the cost become reduced compared to using the conventional linear encoder but also there is no reduction of the accuracy of detection due to adhesion of dirt or dust. In addition, there is no need for complicated assembly adjustments to be made, the handling is easy, and also there is no occurrence of problems due to insufficient assembly adjustments. As a result, it is possible to move the stimulable phosphor plate or the optical unit at a constant speed, and as a consequence, in the case of scanning the stimulable phosphor plate with stimulating excitation light, it is possible to obtain favorable diagnostic images without image non-uniformity. A rotary encoder is well known as the above rotation detecting device.

### BRIEF DESCRIPTION OF THE DRAWINGS

FIG. 1 shows the first preferred embodiment of the present invention, and is a perspective view of the transport mechanism in an image reading apparatus.

FIG. 2 is an X-Z plane plan view diagram of the transport mechanism of FIG. 1.

FIG. 3 is an X-Y plane plan view diagram of the transport mechanism of FIG. 1.

FIG. 4 is a Y-Z plane plan view diagram of the transport mechanism of FIG. 1.

FIG. 5 is a block diagram showing the speed control section of image reading apparatus.

FIG. 6 shows the second preferred embodiment of the present invention, and is a perspective view of the transport mechanism in an image reading apparatus.

FIG. 7 is an X-Z plane plan view diagram of the transport mechanism of FIG. 6.

FIG. 8 is an X-Y plane plan view diagram of the transport mechanism of FIG. 6.

FIG. 9 shows the third preferred embodiment of the present invention, and is a perspective view of the transport mechanism in an image reading apparatus.

FIG. 10 is an X-Z plane plan view diagram of the transport mechanism of FIG. 9.

FIG. 11 is an X-Y plane plan view diagram of the transport mechanism of FIG. 9.

FIG. 12 is a Y-Z plane plan view diagram of the transport mechanism of FIG. 9.

FIG. 13 is a side cross-sectional diagram showing the vibration restraining mechanism.

### DETAILED DESCRIPTION OF THE PREFERRED EMBODIMENTS

The first to third preferred embodiments of the present invention are described in the following while referring to the drawings.

Further, in the present invention, since the stimulable phosphor sheet alone does not have rigidity and its handling within the apparatus is difficult, it is uncommon to handle the stimulable phosphor sheet by itself, and very often it is affixed to a base support such as a metal plate or a resin plate, and is supported by affixing on the inside of a case called a cassette that can be installed or removed easily. In the following explanations, the configuration of the stimulable phosphor sheet supported by the base support or cassette in this manner will be referred to as a stimulable phosphor plate. Further, this stimulable phosphor plate is supported by mounting its base support side on a fixing plate.

This stimulable phosphor plate absorbs the radiation that are passed through the body of the subject during radiographing, and a part of that energy is stored as the information of the radiographic image within the stimulable phosphor. The image reading apparatus according to the present invention is an apparatus that reads out the information of the radiographic image accumulated within the stimulable phosphor in this manner.

### First Preferred Embodiment

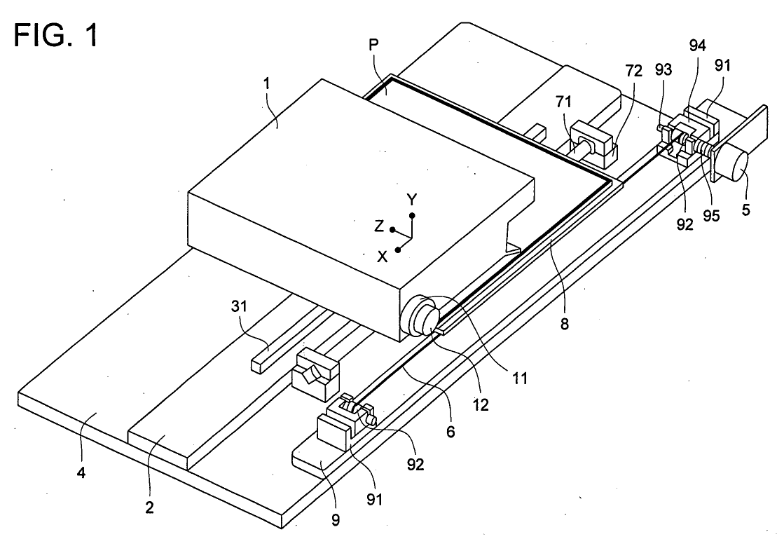

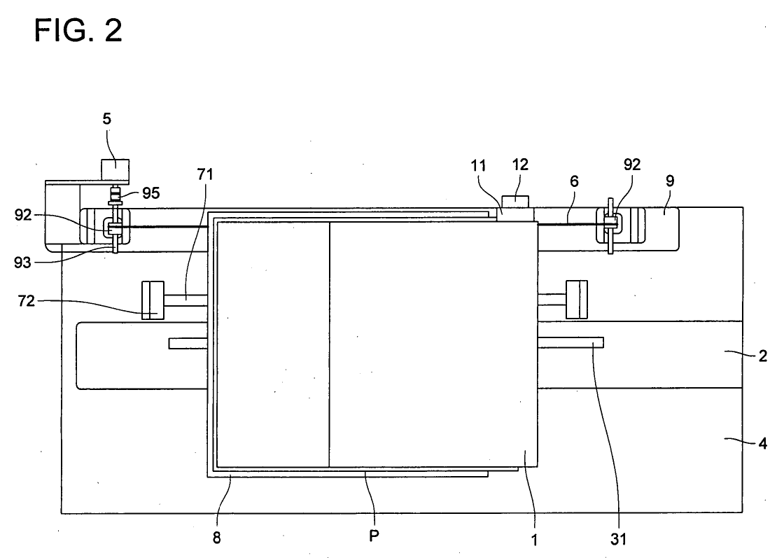

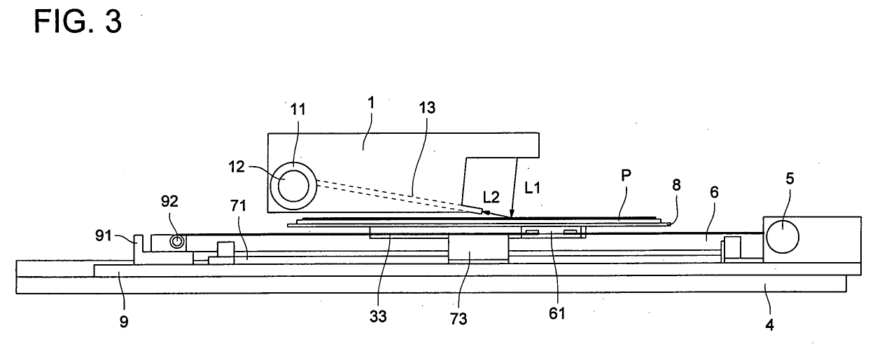

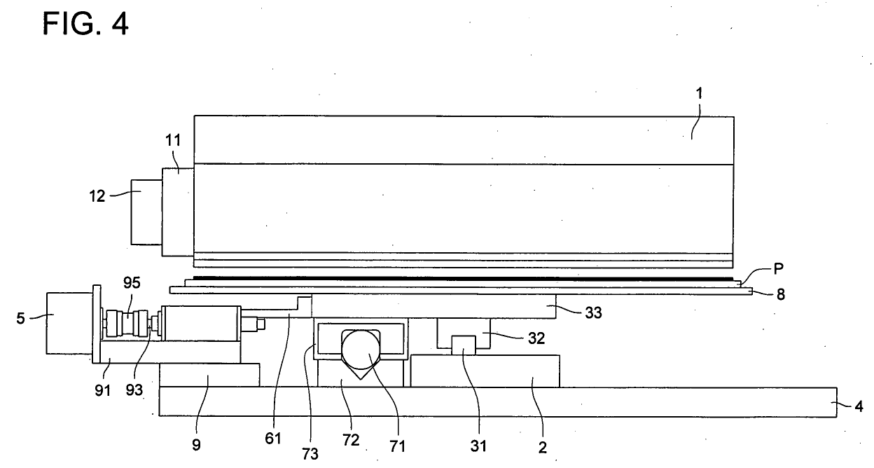

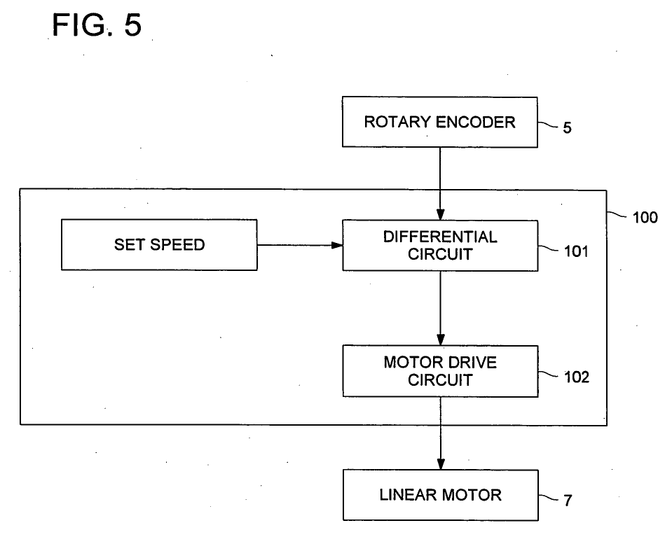

FIG. 1 shows the perspective view of the transport mechanism in an image reading apparatus according to the first preferred embodiment of the present invention, FIG. 2 is an X-Z plane plan view diagram of the transport mechanism of FIG. 1, FIG. 3 is an X-Y plane plan view diagram of the transport mechanism of FIG. 1, FIG. 4 is an Y-Z plane plan view diagram of the transport mechanism of FIG. 1, and FIG. 5 is a block diagram showing the speed control section of image reading apparatus.

As is shown in FIGS. 1 to 4, the image reading apparatus is provided with an optical unit 1 that illuminates the stimulable phosphor plate P with laser light (excitation light) L1 from the laser light emitting apparatus (light source) (not shown in the figure) while scanning it and reads the image information by condensing the photo-stimulated luminescence light L2 emitted from the stimulable phosphor plate P and carrying out photoelectric conversion of this light. The image reading apparatus is also provided with a supporting member 2 that is provided on a base 4 and supports the stimulable phosphor plate P so that it is free to move in the horizontal direction. It is also provided with a linear motor 7 that moves the stimulable phosphor plate P, and a guide rail (guiding member) 31 that is provided on a supporting member 2 and guides the stimulable phosphor plate P in the horizontal direction.

Further, it is provided with a steel wire 6 and a wire connecting body 61 (connecting device) that are coupled to the holding plate 8 to which the stimulable phosphor plate P is attached and which travel along with the stimulable phosphor plate P. It is also provided with pulley 92 and shaft section 93 (rotating device) that rotate due to the movement of the stimulable phosphor plate P transmitted via the wire 6 and the wire connecting body 61, and a rotary encoder 5 that detects the rotational speed of the pulley 92 and shaft section 93. It is further provided with a speed control section (control device) 100 that controls the linear motor 7 by comparing the result of detection by the rotary encoder 5 with a previously determined set speed.

Each of the constituent members is described in detail in the following.

The base 4 has an approximately rectangular shape, and is placed opposing the optical unit 1. Further, the stimulable phosphor plate P is placed between this base 4 and the optical unit 1. The stimulable phosphor plate P is supported and is made free to move by the holding plate 8 attached to its bottom surface.

A supporting member 2 that is of the shape of a long plate that extents in the horizontal direction and that has been fixed so that it is approximately horizontal at nearly the center of the top surface of the base 4. The guide rail 31 that guides the stimulable phosphor plate P in the horizontal direction is provided on the top surface of this supporting member 2.

The guide rail 31 is a bar-shaped member with an approximately rectangular-shaped cross section, and as is shown in FIG. 4, it mates with a guided member 32 that is guided by the guide rail 31 and has an approximately U-shaped cross section. The guided member 32 is affixed to the moving plate 33, and this moving plate 33 is affixed to the holding plate 8 on the bottom surface of the stimulable phosphor plate P.

In this manner, the stimulable phosphor plate P is supported on the base 4 by the supporting member 2, the guide rail 31, the guided member 32, the moving plate 33, and the holding plate 8, etc., and is placed opposing the optical unit 1.

Further, a linear motor supporting member 72 is provided on the top surface of the base 4 and on the side on the supporting member 2 to support the magnet section 71 constituting the linear motor 7. The magnet section 71 is formed in the shape of a shaft by linking either the N poles or the S poles of a plural number of permanent magnets with circular cross sections.

Further, the magnet section 71 is provided with a movable coil 73 that constituents a linear motor 7. The movable coil 73 has a coil formed in a shape of a cylinder, and the coil is covered by a box-shaped covering member. Further, the movable coil 73 is provided on the bottom surface of the movable plate 33, and the linear motor 7 is configured so that the magnet section 71 passes through the center of the movable coil 73.

Furthermore, on the top surface of the base 4, on the side of the linear motor supporting member 72 is fixed approximately horizontally a retaining member 9 with a shape of a long plate that extends in the horizontal direction parallel to the supporting member 2. As is shown in FIG. 1, fixing members 91 with an approximate L-shaped cross section are provided at the both ends in the longitudinal direction on the top surface of the retaining member 9, and a pulley supporting member 94 is provided on top of these fixing member 91 for supporting the pulley 92. The shaft section 93 of the pulley 92 is hooked to this pulley supporting member 94 so that the pulley 92 is supported in a rotatable manner. In addition, a coupling 95 is inserted by the shaft section 93 of one of the pulleys 92, and a rotary encoder 5 that detects the rotation of the shaft section 93 associated with the movement of the wire 6 is coupled to its tip.

Further, the wire 6 is passed around these pulleys 92, and a wire connecting body 61 whose one side is fixed to the side surface of the moving plate 33 is provided on top of this wire 6. The wire connecting body 61 moves the wire 6 in the horizontal direction in association with the movement of the stimulable phosphor plate P.

The rotating shaft of the rotary encoder 5 rotates along with the pulleys 92 and the shaft section 93 that rotate due to the movement of the wire 6, and detects that speed of rotation. Further, the detected rotational speed information is outputted to the speed control section 100 that controls the rotational speed of the linear motor 7.

The speed control section 100, as is shown in FIG. 5 is provided with a differential circuit 101 and a motor drive control circuit 102. The above mentioned rotational speed information corresponding to the movement speed along the horizontal direction of the stimulable phosphor plate P is inputted to the differential circuit 101. Further, the differential circuit 101 processes this rotational speed information and outputs the rotational speed signal, and generates the differential signal by comparing with the set speed signal obtained from the set speed that has been set beforehand. This is outputted as the control signal to the motor drive circuit 102. The motor drive circuit 102 controls the linear motor 7 based on the differential signal.

On the other hand, the optical unit 1 has been fixed at a position opposing the stimulable phosphor plate P by a fixing device not shown in the figure. This optical unit 1 has a laser light emitting apparatus that illuminates the stimulable phosphor plate P with the laser light L1 while scanning in a direction at right angles to the direction of movement of the stimulable phosphor plate P, a light guiding plate 13 that guides the photo-stimulated luminescence light L2 that was excited because the stimulable phosphor plate P was illuminated by the laser light L1 from the laser light emitting apparatus, a light condensing tube 11 that condenses the photo-stimulated luminescence light L2 guided by the light guiding plate 13, and a photoelectric converter 12 that converts the photo-stimulated luminescence light L2 condensed by the light condensing tube 11 to electrical signals.

Further, in the image reading apparatus of the present invention, although not shown in the figure, an erasing apparatus is provided that emits erasing light towards the stimulable phosphor plate P after the processing is completed of reading the radiation energy by the optical unit 1 in order to release the radiation energy remaining in the stimulable phosphor plate P.

Next, the operation of the image reading apparatus constituted as described above is explained in the following.

The stimulable phosphor plate P is taken inside the image reading apparatus by the transporting device, and is fixed to the holding plate 8. At the time of reading an image, to begin with, the linear motor 7 is driven, and the holding plate 8 supporting the stimulable phosphor plate P is moved in the horizontal direction along the guide rail 31.

Because of this, the stimulable phosphor plate P is moved to a position opposite to the laser light emission surface of the optical unit 1 and is scanned by the laser light L1 from the laser light emission apparatus due to the horizontal movement of the optical unit 1. At this time, the laser light L1 is emitted while being scanned in a direction at right angles to the direction of movement of the stimulable phosphor plate P. As a consequence, the photo-stimulated luminescence light L2 is guided by the light guiding plate 13 and is condensed by the light condensing tube 11, and is converted into electrical signals by the photoelectric converter 12.

Because the stimulable phosphor plate P moves in the horizontal direction in this manner, this movement is transmitted to the wire 6 via the wire connecting body 61 provided on the moving plate 33, and the pulleys 92 and the shaft section 93 rotate accordingly. In association with this, the speed of this rotation is detected by the rotary encoder 5 coupled to the shaft section 93, and the result of this detection is outputted to the speed control section 100.

The rotational speed detected by the rotary encoder 5 is compared with the set speed signal obtained from the set speed that has been set beforehand in the differential circuit 101, and according to that result, the motor drive circuit 102 controls the drive of the linear motor 7.

Further, a widely known method is used as the driving method of the linear motor 7. For example, it is possible to control the speed of movement of the linear motor 7 by varying the frequency and voltage of the AC drive current by inverter control. Also, using PWM control, it is also possible to carry out the control using the pulse width of the pulse voltage to be inputted to the movable coil of the linear motor 7. Further, if it is a stepping motor, it is possible to control the movement speed by setting the period of the pulse to be inputted to the linear motor 7.

In this manner, by continuously detecting the speed of the rotary encoder 5, and by carrying out speed control of the linear motor 7 based on the result of that detection, it is possible to maintain a constant movement speed of the stimulable phosphor plate P. Therefore, it is possible to excite uniformly the radiation energy accumulated in the stimulable phosphor plate P, and to obtain favorable images without image non-uniformity.

The linear motor 7 is stopped when the processing of reading by the optical unit 1 is completed up to one end of the stimulable phosphor plate P.

After that, erasing light is emitted towards the stimulable phosphor plate P by an erasing apparatus not shown in the figure, and because of this, the radiographic image remaining in the stimulable phosphor plate P is erased. Thereafter, the stimulable phosphor plate P is transported to outside the image reading apparatus by the transporting device.

As above, according to the image reading apparatus of the first preferred embodiment of the present invention, the stimulable phosphor plate P is moved by the linear motor 7, and in association with this, this movement is transmitted via the wire connecting body 61 to the wire 6 and the pulleys 92 and the shaft section 93 rotate, and then the speed of this rotation is detected by the rotary encoder 5. Further, the result of detection by the rotary encoder 5 and the set speed are compared by the speed control section 100, and the linear motor 7 is controlled so that the speed of movement of the stimulable phosphor plate P becomes constant. In this manner, by carrying out speed control of the linear motor 7 using a rotary encoder 5, not only does the cost become reduced compared to the conventional linear encoder, but also there is no reduction of the accuracy of detection due to adhesion of dirt or dust. In addition, there is no need for complicated assembly adjustments to be made, the handling is easy, and also there is no occurrence of problems due to insufficient assembly adjustments.

As a result, it is possible to move the stimulable phosphor plate P at a constant speed, and as a consequence, in the case of scanning the stimulable phosphor plate P with stimulating excitation light L1, it is possible to obtain favorable diagnostic images without image non-uniformity.

### Second Preferred Embodiment

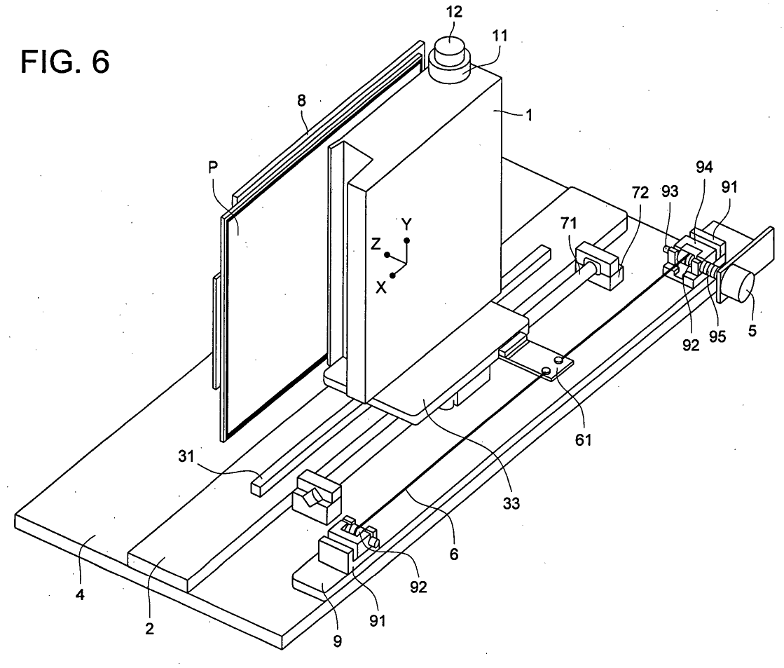

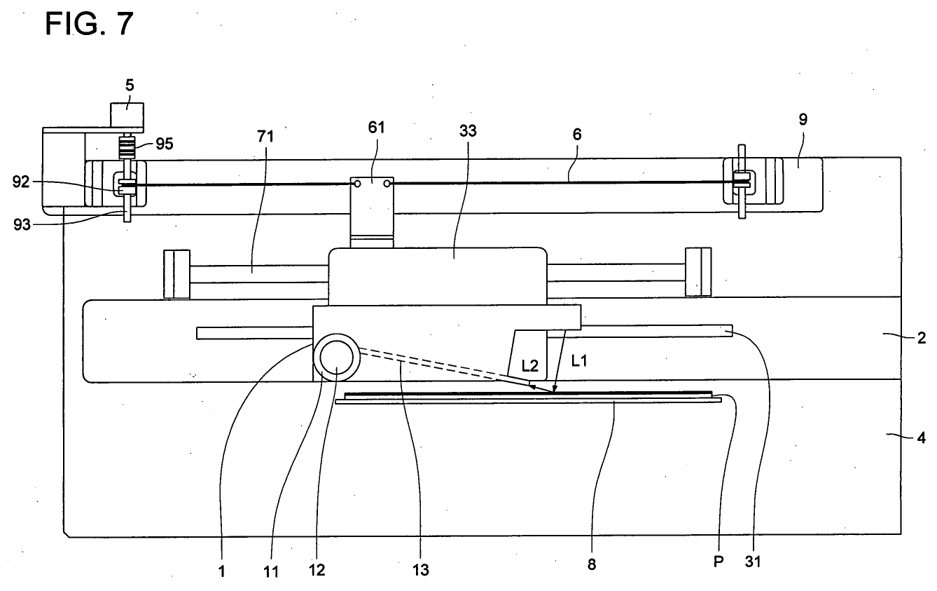

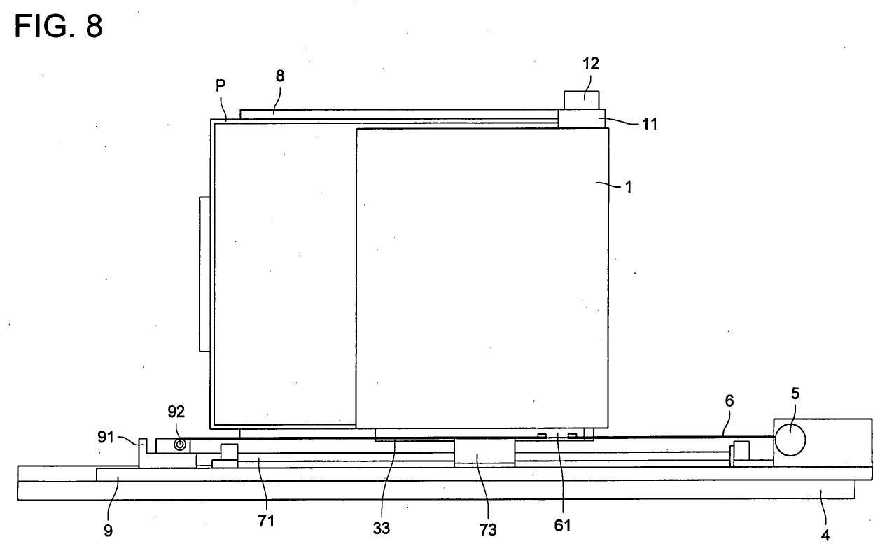

FIG. 6 shows the second preferred embodiment of the present invention, and is a perspective view of the transport mechanism in an image reading apparatus, FIG. 7 is an X-Z plane plan view diagram of the transport mechanism of FIG. 6, and FIG. 8 is an X-Y plane plan view diagram of the transport mechanism of FIG. 6.

The image reading apparatus according to the second preferred embodiment of the present invention is different from the first preferred embodiment, and is configured so that the stimulable phosphor plate P is fixed to the base 4 and the optical unit 1 moves in the horizontal direction.

In other words, as is shown in FIGS. 6 to 8, the stimulable phosphor plate P is supported so that the top surface of the base 4 and the laser light illumination surface of the stimulable phosphor plate P are approximately vertical. This stimulable phosphor plate P is installed so that its surface on the side of the base support is affixed to the holding plate 8 that is fixed on top of the base 4.

In addition, the optical unit 1 has been made free to move in the horizontal direction due to the moving plate 33 and the guided member 32 that mates with the guide rail 31 of the supporting member 2 fixed approximately at the center of the base 4.

Since all other aspects of the configuration are identical to that in the first preferred embodiment described above, the same symbols have been assigned and their explanations have been omitted.

As the above, according to the image reading apparatus of the second preferred embodiment of the present invention, the optical unit 1 is moved by the linear motor 7, in association with this, this movement is transmitted via the wire connecting body 61 to the wire 6 and the pulleys 92 and the shaft section 93 rotate, and the speed of this rotation is detected by the rotary encoder 5. Further, the result of detection by the rotary encoder 5 and the set speed are compared by the speed control section 100, and the linear motor 7 is controlled so that the speed of movement of the optical unit 1 becomes constant. In this manner, by carrying out speed control of the linear motor 7 using a rotary encoder 5, not only does the cost become reduced compared to the conventional linear encoder, but also there is no reduction of the accuracy of detection due to adhesion of dirt or dust. In addition, there is no need for complicated assembly adjustments to be made, the handling is easy, and also there is no occurrence of problems due to insufficient assembly adjustments.

As a result, it is possible to move the optical unit 1 at a constant speed, and as a consequence, in the case of scanning the stimulable phosphor plate P with stimulating excitation light L1, it is possible to obtain favorable diagnostic images without image non-uniformity.

### Third Preferred Embodiment

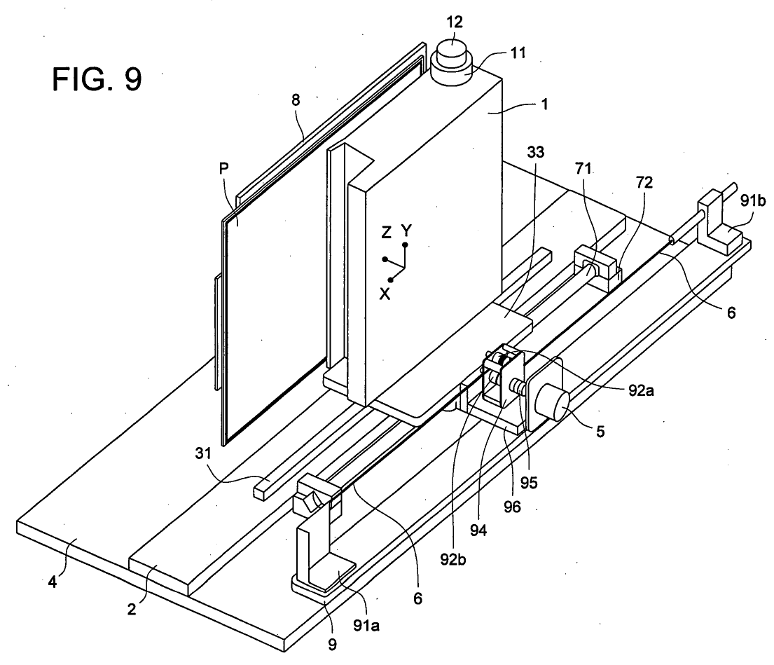

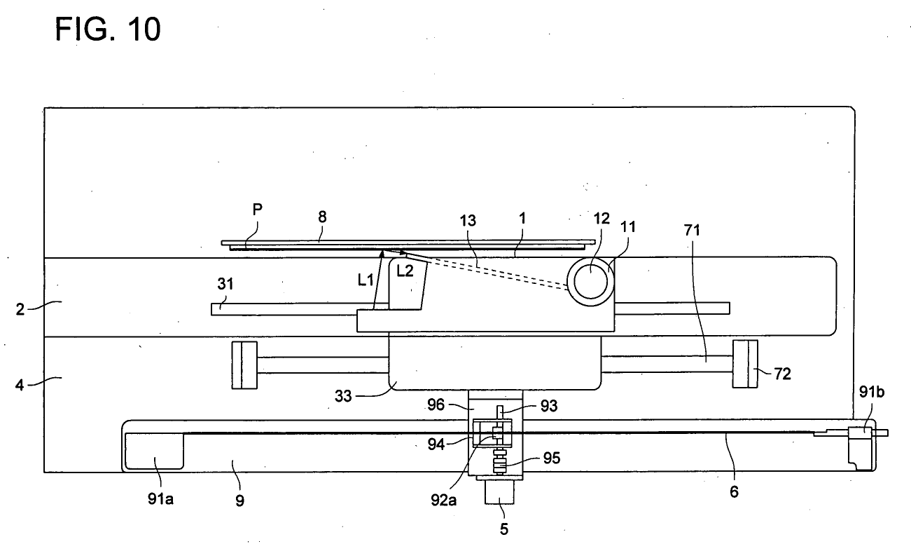

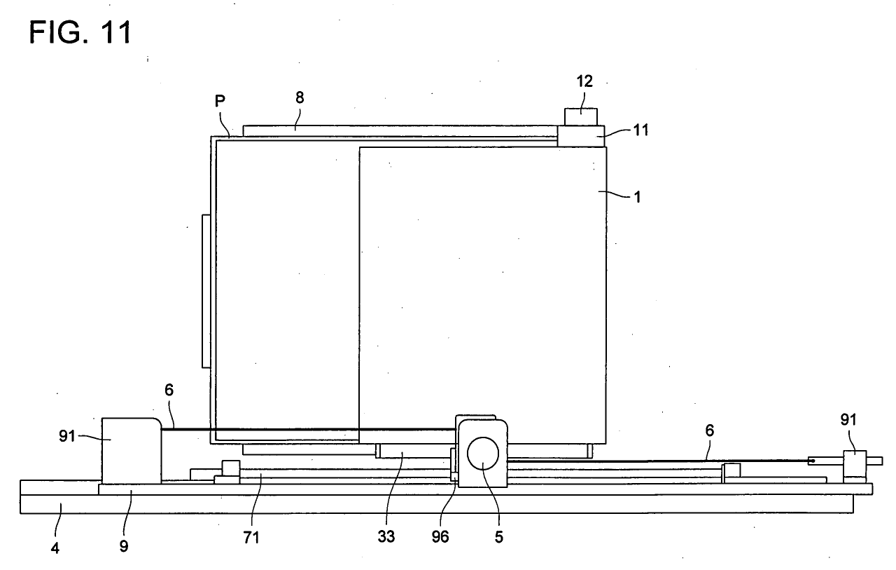

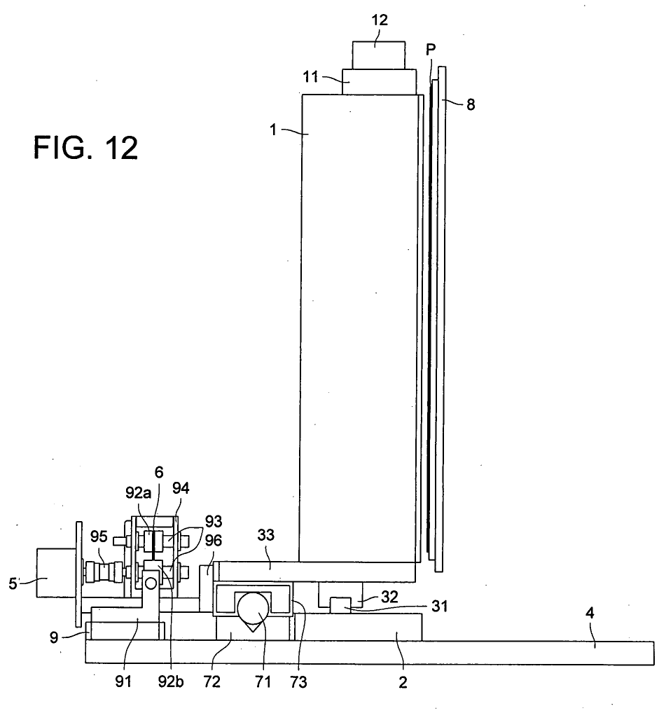

FIG. 9 shows the third preferred embodiment of the present invention, and is a perspective view of the transport mechanism in an image reading apparatus, FIG. 10 is an X-Z plane plan view diagram of the transport mechanism of FIG. 9, FIG. 11 is an X-Y plane plan view diagram of the transport mechanism of FIG. 9, and FIG. 12 is an Y-Z plane plan view diagram of the transport mechanism of FIG. 9.

The image reading apparatus according to the third preferred embodiment of the present invention has a configuration similar to the configuration of the second preferred embodiment in which the optical unit 1 travels in the horizontal direction relative to the stimulable phosphor plate P. However, unlike the second preferred embodiment, the rotary encoder 5 travels in the horizontal direction relative to the fixed wire 6 in association with the movement of the optical unit 1.

In other words, as is shown in FIGS. 9 to 12, a movable stage (connecting device) 96 which travels along the horizontal direction and which has an approximately L-shaped cross section is provided on the side of the moving plate 33 provided on the bottom surface of the optical unit 1 and above the top surface of the retaining member 9. One side of this movable stage 96 is fixed to the side surface of the moving plate 33 of the optical unit 1 and its other side is positioned above the top surface of the retaining member 9.

In addition, a pulley supporting section 94 for supporting the pulleys 92a and 92b placed above and below is provided on the top surface of the movable stage 96. The shaft sections 93 of each of these pulleys 92a and 92b are mounted in this pulley supporting section 94, and the pulleys 92a and 92b are supported in a rotatable manner. It is desirable that the diameters of these top and bottom pulleys 92a and 92b are different from each other.

Further, the coupling 95 is inserted by the shaft section 93 of the lower side pulley 92b, and the rotary encoder 5 that detects the rotation of the shaft section 93 associated with the movement of the wire 6 is coupled to the tip of this.

In addition, fixing members 91a and 91b with approximately L-shaped cross-sections are provided respectively at the both ends along the longitudinal direction on the top surface of the retaining member 9, and the both ends of the wire are fixed to these fixing members 91a and 91b, and the pulleys 92a and 92b on the top and bottom sides are provided to be wound by the wire 6.

The rotating shaft of the rotary encoder 5 rotates along with the pulleys 92a and 92b and the shaft sections 93 that rotate due to the movement of the optical unit 1 and the movable stage 96 thereby detecting the rotational speed. Further, the rotation speed information that has been detected is outputted to the speed control section 100 that controls the speed of movement of the linear motor 7.

Since all other aspects of the configuration are identical to that in the second preferred embodiment described above, the same symbols have been assigned and their explanations have been omitted.

As the above, according to the image reading apparatus of the third preferred embodiment of the present invention, the optical unit 1 is moved by the linear motor 7, and in association with this, the movable stage 96 travels over the retaining member 9, then this movement is transmitted to the pulleys 92a and 92b and to the shaft section 93 which rotate consequently, and then the speed of this rotation is detected by the rotary encoder 5. Further, the result of detection by the rotary encoder 5 and the set speed are compared by the speed control section 100, and the linear motor 7 is controlled so that the speed of movement of the optical unit 1 becomes constant. In this manner, by carrying out speed control of the linear motor 7 using a rotary encoder 5, not only does the cost become reduced compared to the conventional linear encoder, but also there is no reduction of the accuracy of detection due to adhesion of dirt or dust. In addition, there is no need for complicated assembly adjustments to be made, the handling is easy, and also there is no occurrence of problems due to insufficient assembly adjustments.

As a result, it is possible to move the optical unit 1 at a constant speed, and as a consequence, in the case of scanning the stimulable phosphor plate P with stimulating excitation light L1, it is possible to obtain favorable diagnostic images without image non-uniformity.

In addition, although the shapes of the pulleys may not be exactly circular due to machining accuracy, by making the pulleys 92a and 92b placed at the top and bottom have different diameters, even if the shapes of the pulleys are not exactly circular, it is possible to reduce the frequency of the phase of the two pulleys becoming matched, and to improve the accuracy of detection.

Further, the preferred embodiments of the present invention need not be restricted to the above preferred embodiments, and appropriate changes can be made without deviation from the spirit of the invention.

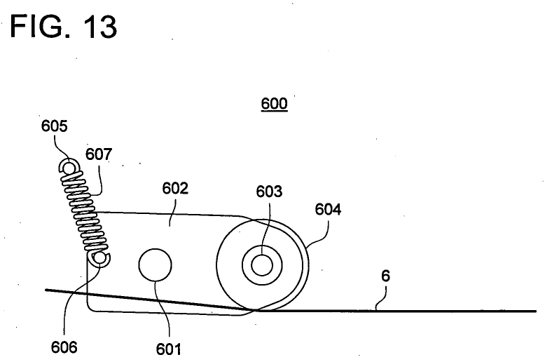

It is desirable that a vibration restraining mechanism 600 is provided to the steel wire 6 as is shown in FIG. 13 to absorb the vibrations of the wire 6 and to suppress the vibrations from reaching the stimulable phosphor plate P or the optical unit 1. The vibration restraining mechanism 600 comprises a side plate 602 that can swing centering on the pivot shaft 601, a roller 604 that presses the wire 6 that is provided at one end of this side plate 602 via the roller rotation shaft 603, a shaft section 605 provided on the frame (not shown in the figure), and a tension spring 607 that is hooked to the shaft section 606 provided on the side plate 602 and that applies a force pressing the side plate 602 towards the wire 6. Consequently, due to the force of the tension spring 607, and due to the side plate 602 swinging centering on the pivot shaft 601, it is possible to absorb the vibrations of the wire 6 and to maintain the rotational accuracy of the rotary encoder 5 at a favorable value.

Further, it is also possible to use a belt etc., instead of the wire 6.

In the above third preferred embodiment, although two pulleys 92a and 92b have been provided above and below, it is not necessary to restrict the number of pulleys to two but it is also possible to provide three or more pulleys.

Further, although the guide rail 31 here is taken to be a bar-shaped member with an approximately rectangular cross-sectional shape, it is also possible to have a roughly circular-shaped cross section.

What is claimed is:

1. An image reading apparatus in which excitation light is irradiated to a stimulable phosphor plate having a stimulable phosphor sheet and image information is read, comprising:
a stimulable phosphor plate holding plate to support and hold the stimulable phosphor plate;
an optical unit to read image information by condensing and photoelectrically converting stimulated luminescence emitted from the stimulable phosphor plate while scanning and irradiating excitation light from a light source to the stimulable phosphor plate;
a linear motor to transfer a transferring member,
wherein one of the stimulable phosphor plate holding plate and the optical unit is the transferring member;
a connecting device transferring with the transferring member;
a rotating device to be rotated by transmission of movement of the transferring member via the connecting device;
a rotation detecting device to detect rotating speed of the rotating device; and
a control device to control the linear motor by comparing a detecting result of the rotation detecting device and previously set speed.

2. The image reading apparatus of claim 1,
wherein the transferring member is the stimulable phosphor plate holding plate.

3. The image reading apparatus of claim 1,
wherein the transferring member is the optical unit.

4. The image reading apparatus of claim 1,
wherein the connecting device has a vibration restraining mechanism to restrain vibration transmitted to the transferring member.

5. The image reading apparatus of claim 1,
wherein the connecting device includes a belt or a wire and the rotating device includes a plurality of pulleys which are wound around by the belt or the wire and diameters of which differs from each other.
